(19) United States
(12) Patent Application Publication
(10) Pub. No.: US 2025/0290461 A1
(43) Pub. Date: Sep. 18, 2025

(54) SYSTEMS, METHODS, AND APPARATUSES FOR HIGH-PRESSURE FUEL PUMP DIAGNOSTICS

(71) Applicant: Cummins Fuel Systems (Wuhan) Co., Ltd., Wuhan (CN)

(72) Inventors: Qi An, Wuhan (CN); Ye Ran, Wuhan (CN)

(21) Appl. No.: 19/074,976

(22) Filed: Mar. 10, 2025

(30) Foreign Application Priority Data
Mar. 15, 2024 (CN) 202410303435.7

(51) Int. Cl. F02D 41/22; F02D 41/30

(52) U.S. Cl. CPC F02D 41/22; F02D 41/3082; F02D 2041/224; F02D 2200/0602

(57) ABSTRACT

A system includes an engine comprising a plurality of combustion chambers, a fueling system comprising a fuel rail in fluid communication with a plurality of fuel injectors, each of the plurality of fuel injectors being configured to provide fuel to a respective one of plurality of combustion chambers, and a high-pressure fuel pump in fluid communication with the fuel rail, and an electronic control system in operative communication with the fueling system. The electronic control system is configured to diagnose a condition of the high-pressure fuel pump in response to pressure sensor outputs of the pressure in the fuel rail.

### TECHNICAL FIELD

The present disclosure relates to internal combustion engines, and more particularly to diagnostics for high-pressure fuel pumps for internal combustion engines.

### BACKGROUND

Internal combustion engines employ fuel systems with many components. For example, fuel system components can include injectors, fuel rails, valves, meters, filters, high-pressure fuel pumps, low-pressure fuel pumps, and associated plumbing and connections. It is important to be able to deliver the desired fuel quantity using these components at precise timing in order to operate the internal combustion engine. Faults, leaks, deterioration, and other issues in the fuel system components can cause poor or undesired engine performance, increased maintenance, and even stranded vehicles.

Diagnostics of fuel systems for internal combustion engines, including high-pressure fuel pumps, suffer from a number of shortcomings, including those respecting accuracy, complexity, computational burden, precision, reliability, and robustness, among other shortcomings. There remains a significant need for the unique apparatuses, processes, systems, and techniques disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY

One embodiment is a unique system for testing or diagnosing a high-pressure fuel pump for an internal combustion engine using pressure sensor outputs from a pressure sensor connected to a fuel rail. Another embodiment is a unique method for testing or diagnosing the high-pressure fuel pump. Another embodiment is a unique apparatus for testing or diagnosing the high-pressure fuel pump. Further embodiments, forms, objects, features, advantages, aspects, and benefits shall become apparent from the following description and drawings.

### BRIEF DESCRIPTION OF THE FIGURES

FIG. 1 is a schematic diagram illustrating certain aspects of an example system and apparatus for high-pressure fuel pump diagnostics.

FIG. 2 is a schematic diagram illustrating certain aspects of an example method for high-pressure fuel pump diagnostics.

FIG. 3 is a graph illustrating certain aspects of example operations of example methods and systems.

### DETAILED DESCRIPTION OF EXAMPLE EMBODIMENTS

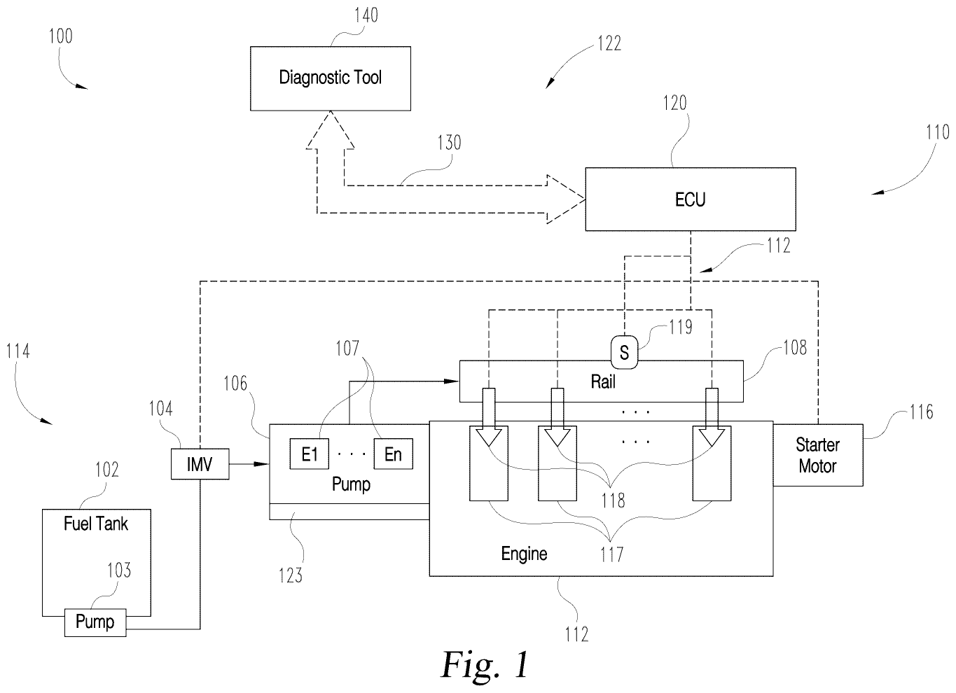

FIG. 1 illustrates an embodiment of a system 100 including a diagnostic tool 140 and an engine system 110. The diagnostic tool 140 may be selectably operatively coupled with and in operative communication with an electronic control unit (ECU) 120 of engine system 110 via one or more communication links 130. Diagnostic tool 140 and communication links 130 may be provided in a number of forms and when connected form an electronic control system 122 in conjunction with ECU 120. Diagnostic tool 140 can also be a stand-alone tool, a software tool used on a computer, an application tool on a smart device such as a phone or tablet, or a telematics based cloud tool.

Engine system 110 includes an engine 112 with a plurality of combustion chambers 117. A fueling system 114 includes a fuel rail 108 in fluid communication with a plurality of fuel injectors 118. Each of the plurality of fuel injectors 118 is configured to provide fuel to a respective one of the plurality of combustion chambers 117. A high-pressure fuel pump 106 is in fluid communication with the fuel rail 108, and the high-pressure fuel pump 106 includes a plurality of cylinders 107 with pumping elements (E1 . . . En).

The electronic control system 122 is in operative communication with the fueling system 114 and configured to operate the high-pressure fuel pump 106, receive pressure sensor output indicative of a fuel pressure of the fuel rail 108 during the diagnostic, determine a pressure rise difference between each of the plurality of cylinders 107 of high-pressure fuel pump 106 during the diagnostic based on the pressure sensor output, and in response to the pressure rise difference, display an operator perceptible output indicative of a condition of the high-pressure fuel pump 106 and/or diagnose a condition of the high-pressure fuel pump 106.

Embodiments of fueling system 114 may include a synchronous fuel pump in which the pumping and injection ratio are constant, or a timed fuel pump in which the pumping phase is fixed at manufacturing. In these embodiments, the pumping phase is known and used in the diagnostic of cylinders 107 without inhibiting fuel injection by fuel injectors 118.

For embodiments of fueling system 114 with a non-timed but synchronous fuel pump where the pumping to injection ratio is an integer, but the pumping phase is unknown, injection events can be inhibited to measure and determine the fuel pump phasing. Once the fuel pump phasing is determined, the fuel pressure and pumping data between different cylinders 107 can be determined without inhibiting injection. Injection may need to be inhibited in cases where there is an overlap between pumping and injection.

For embodiments of fueling system 114 with a non-synchronous fuel pump, the injection event is inhibited to determine phasing and also during measuring the fuel pressure and pumping data between different cylinders 107 is determined. This is because injection and pumping can be mixed, effecting the fuel pressure measurements and determination of pumping imbalance between cylinders 107.

In some embodiments, diagnostic tool 140 may be implemented and executed in connection with one or more computing devices present at the location of engine system 110 (e.g., at a service bay or another point-of-service at which engine system 110 is located). In such embodiments, communication links 130 may include one more physical connections with engine system 110, for example, via an OBD II interface, a J1939 interface, or various other interfaces. In some embodiments, diagnostic tool 140 can be hard-wired to an external service tool, or can be a stand-alone device.

In some embodiments, diagnostic tool 140 may be implemented and executed in connection with one or more computing devices located remotely from engine system 110 and communication links 130 may include one more networks including wired and/or wireless networks or network components configured and operable to provide communication between diagnostic tool 140 and ECU 120 of engine system 110. Some such embodiments may include one or more computing devices located remotely from engine system 110 and in communication with ECU 120 of engine system 110 via a telematics system. Some such embodiments may include a combination of one or more computing devices located remotely from engine system 110 and one or more computing devices present at the location of engine system 110 (e.g., at a service bay or another point-of-service at which engine system 110 is located) that communicate through remote communication such as cloud-based telematics data.

While diagnostic tool 140 is depicted in FIG. 1 as external to engine system 110, on some embodiments, diagnostic tool 140 may be embedded or otherwise provide in engine system 110. In some such embodiments, diagnostic tool 140 may be embedded or otherwise provided in and executed by ECU 120 and/or other components of an electronic control system (ECS) of engine system 110. In some such embodiments communication links 130 may include one or more intra-ECU or intra ECS communication channels or may be omitted in instances where a communication link is not required, such as with an internal diagnostic tool that is part of ECU 120 and/or the ECS 122.

Engine system 110 may further include a starter motor 116 operatively coupled with engine 112 and ECU 120, and fueling system 114 operatively coupled with engine 112 and ECU 120. In the illustrated embodiment engine 112 is a direct-injection, reciprocating piston-type internal combustion engine configured and operable to combust fuel injected by one or more fuel injectors 118 directly into one respective ones of a plurality of combustion chambers 117. It shall be appreciated that engine 112 may be configured and provided in various forms including various numbers of combustion chambers 117 and various numbers of fuel injectors 118.

In the illustrated embodiment, fueling system 114 is configured and provided as a high-pressure common-rail (HPCR) fueling system. In other embodiments, fueling system may be provided in various other forms as will occur to one of skill in the art with the benefit and insight of the present disclosure. Fueling system 114 includes fuel rail 108, which receives pressurized fuel from high-pressure fuel pump 106 and provides pressurized fuel to fuel injectors 118. In the illustrated embodiment, fuel pump 106 is provided and configured as a high-pressure fuel pump with a plurality of cylinders 107 having corresponding pump elements (E1 . . . En). In an embodiment, high-pressure fuel pump 106 includes a plurality of piston-in-cylinder-type pump elements (E1 . . . En) in respective ones of the cylinders 107 that configured to pressurize fuel received by fuel pump 106 and provide the pressured fuel from each of the cylinders 107 to fuel rail 108.

In an embodiment, high-pressure fuel pump 106 is a fuel pump that pressurizes fuel in fuel rail 108 by reciprocal movement of pump elements (E1 . . . En) via cam lobes on a pump camshaft that rotate in a timed relationship to the engine crankshaft 123. ECU 120 is in operative communication with and configured to receive engine position measurements or signals, such as an engine position sensor, which is used to correlate crank angle position of crankshaft 123 to the position of the pump elements (E1 . . . En) in order to determine a pumping phase of the pump elements (E1 . . . En).

Other embodiment contemplate other techniques to determine the pumping phase of the pump elements (E1 . . . En) with crankshaft 123, such as a look-up table or the like. As a result, as discussed further below, the particular pumping element (E1 . . . En) and the pressure sensor signal output it creates in fuel rail 108 can be identified. As discussed above, for embodiments with a synchronous fuel pump, the pumping phase is pre-determined. For some embodiments of non-synchronous fuel pump, pumping phase determination may not be needed.

In an embodiment, engine 112 has a number of combustion chambers 117 formed by a corresponding number of cylinders of engine 112. For example, engine 112 may be provided with four or six cylinders that each include a combustion chamber to receive fuel from a corresponding fuel injector 118. In an embodiment, high-pressure fuel pump 106 is provided and configured as a 3-cylinder pump, with each pump cylinder producing two pumping events per pump camshaft revolution. Other embodiments contemplate other numbers of pumping events per pump camshaft revolution, such as one pumping event or three or more pumping events per pump camshaft revolution. Other embodiments contemplate a high-pressure fuel pump 106 with two cylinders, or four or more cylinders. It shall be appreciated that this configuration is example of an engine system suitable for operation according to the apparatuses, controls, diagnostic, processes, systems, and techniques of the present disclosure.

An inlet metering valve (IMV) 104 is provided at or upstream from an inlet to fuel pump 106 and is operatively coupled with and controllable by ECU 120 to meter or regulate flow of fuel into fuel pump 106. It shall be appreciated that IMV 104 may also be referred to as a volume control valve, flow control valve, magnetic proportional valve, or various other terms of art. An IMV 104 may alternatively be provided at the inlet of each cylinder 107 of fuel pump 106.

Each IMV 104 is configured and operable to receive fuel pumped from fuel tank 102 by pump 103, which may be configured and provided as a low-pressure fuel pump. ECU 120 is in operative communication with and configured to electronically control IMV(s) 104 between a fully closed position which permits minimum fuel flow to fuel pump 106 (e.g., substantially no fuel flow) and a fully open position which permits maximum fuel flow to cylinders 107 of fuel pump 106.

ECU 120 is also in operative communication with and configured to receive pressure measurements from pressure sensor 119, which is configured to sense pressure of fuel in fuel rail 108. In an embodiment, pressure sensor 119 is a high precision fast response pressure sensor that measure pressure in fuel rail 108 at a response rate of 2 milli-seconds or less. In an embodiment, pressure sensor 119 is capable of producing high frequency output for the pressure measurements in fuel rail 108. In an embodiment, the high frequency signals from the pressure sensor output are 10 kilo-Hertz. Other embodiments contemplate other high frequencies based on processor capabilities and algorithm requirements.

ECU 120 is further in operative communication with and configured to control operation of fuel injectors 118 to inject fuel in to combustion chambers 117 of engine 112. ECU 120 is in operative communication with and configured to control fuel injectors 118 between a fully closed position, which permits no fuel injection to combustion chambers 117, and an open position, which permits fuel injection. ECU 120 is also in operative communication with and configured to provide control signals to selectably operate starter motor 116 to crank engine 112. Control signals to operate starter motor 116 to crank engine 112 may additionally or alternatively be provided in response to a technician commanding or triggering engaging or operation of starter motor 116. In some embodiments, an automated starter may be present and may also be controllable via a body control module and may include a push button for manual starting.

ECU 120 is an example of a component of ECS 122 configured and operable to execute operating logic that defines various control, diagnostic, management, and/or regulation functions. For example, the non-transitory memory medium may be configured with instructions executable by the processor to perform a number of acts, evaluations, or operations including those described herein. The operating logic of ECU 120 or other ECS 122 components may be in the form of dedicated hardware, such as a hardwired state machine, analog calculating machine, programming instructions, and/or a different form as would occur to those skilled in the art.

While ECU 120 is depicted as single unit in the illustrated example, it shall be appreciated that one or more processor, one or more non-transitory memory medium, and related components may be provided as or distributed across or among multiple units or physical packages. For example, one or more processors, such as programmable microprocessors or microcontrollers of a solid-state, integrated circuit type which may be provided in one or more control units and can be implemented in any of a number of ways that combine or distribute the control function across one or more control units in various manners. Other components or subsystems of ECU 120 and/or its associated ECS 122 may also be so configured or provided.

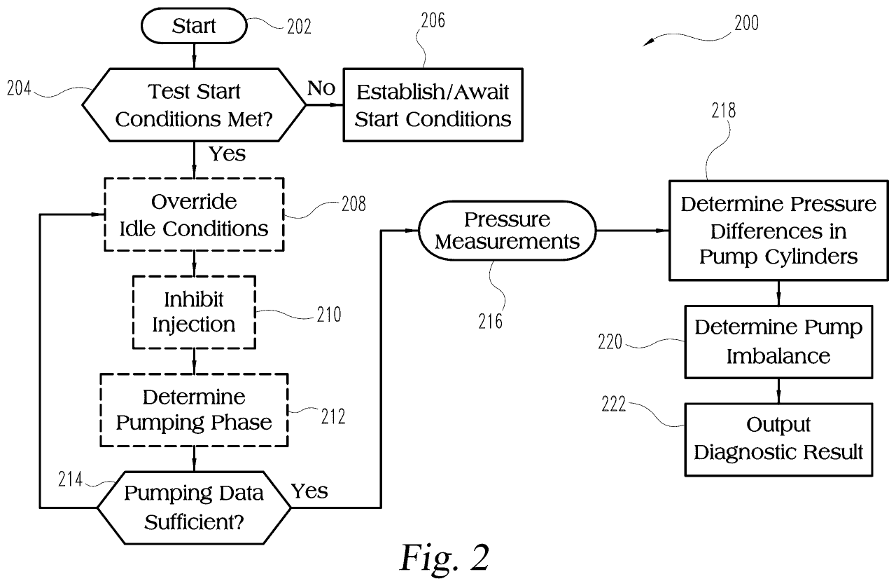

With reference to FIG. 2, there is illustrated an example method 200 which may be implemented and performed, in whole or in part, in connection with a system such as system 100. Method 200 is one example of a method according to the present disclosure for performing a diagnostic or test of a fuel pump such as high-pressure fuel pump 106.

Method 200 begins at start operation 202 and proceeds to conditional 204 which tests whether one or more test or diagnostic start conditions is or are satisfied. The one or more test or diagnostic start conditions may include a number of conditions that may vary according to the particular system with which method 200 is performed.

For example, the one or more test or diagnostic start conditions may include engine and/or fuel system conditions that may be established or selected to provide operating conditions required or desirable for testing a fuel pump such as high-pressure fuel pump 106. Such conditions may include, for example, the presence of or absence or certain fault codes for engine 112, pressure sensor 119, or other component of fuel system 114, engine 112 operating at idle conditions, an open or closed status of IMV 104, a pressure such as a fuel pressure of fuel rail 108 being below or above a threshold value, or other conditions indicative of or suitable as proxies for a condition of engine 112 and/or of a fueling system such as fueling system 114.

In some embodiments, the one or more test start conditions may include an initiation of a test or diagnostic by a technician and/or a diagnostic tool such as diagnostic tool 140. Such embodiments may include, for example, embodiments in which method 200 is performed during an out-of-mission diagnostic, service or repair event.

In some embodiments, the one or more test or diagnostic start conditions may include a key-on condition and/or one or more engine start or engine idle conditions. Such embodiments may include, for example, embodiments in which method 200 is performed each time an engine such as engine 112 is started during operation or on a regular or periodic basis when an engine is started or in combination with events such as the detection of error, failure, or fault conditions potentially related to a high-pressure fuel pump.

If conditional 204 evaluates negative, method 200 proceeds to operation 206 at which method 200 establishes and/or awaits the establishment of the start conditions evaluated by conditional 204. If conditional 204 evaluates affirmative, method 200 proceeds to an optional operation 208, which may override one or more idle conditions for engine 112 and fuel system 114. For example, operation 208 may include increasing a speed of engine 112 above an idle speed while decreasing a pressure in fuel rail 108 below a nominal idle pressure. In a specific example, a speed of engine 112 can be increased to 1800 revolutions per minute while the pressure in fuel rail 108 is lowered to 500 bar. Other examples contemplate other engine speeds, such as idle speed, and fuel rail pressures can be employed.

From operation 208, method 200 may proceed at an optional operation 210, which inhibits injection by fuel injectors such as, fuel injectors 118, for example, by inhibiting injection control signals or otherwise controlling the fuel injectors 118 to perform no injection. For example, as discussed above, inhibiting injection for a non-synchronous fuel pump can be used to measure consecutive pumping data directly without determining the pumping phase. For a non-timed synchronous pump, inhibiting injection can be used to determine the pumping phase at an optional operation 212. For a timed and synchronous fuel pump in which the pumping and injection ratio are constant, the pumping phase is already known and need not be determined, and inhibiting injection is not required.

Optional operation 212 determines the pumping phase of pumping elements (E1 . . . EN) of high-pressure fuel pump 106 that is non-timed and synchronous. The determination of the pumping phase at operation 212 collects pumping data, including high frequency signals for pressure measurements from pressure senor 119. Operation 210 associates each pumping element (E1 . . . En) to the corresponding high frequency pressure signals produced by each pumping element (E1 . . . En) as indicated by the pressure sensor measurements in fuel rail 108 collected from the pressure sensor outputs of pressure sensor 119. The pumping elements (E1 . . . En) can be correlated to the crank angle position of crankshaft 123 and corresponding rotational position of the pump camshaft that moves pumping elements (E1 . . . En) so that the pressure signal output produced by each pumping element (E1 . . . En) can be identified.

From operation 212, method 200 proceeds to conditional 214 to determine if sufficient pumping data has been collected during operation 212 to perform the diagnostic or test. If conditional 214 evaluates negative, method 200 returns to operation 208 and re-set the idle override conditions for engine 112. For example, since fuel injection has been inhibited, engine speed will decrease from the override speed and fuel rail pressure will increase from the override pressure during operation 212. When engine speed reaches a lower limit and/or fuel rail pressure reaches an upper limit, then conditional 214 can evaluate whether sufficient pumping data has been collected to perform the diagnostic or test. Thus, if conditional 214 evaluates negative, data collection override conditions are re-established at operation 208 to collect more pressure sensor output data.

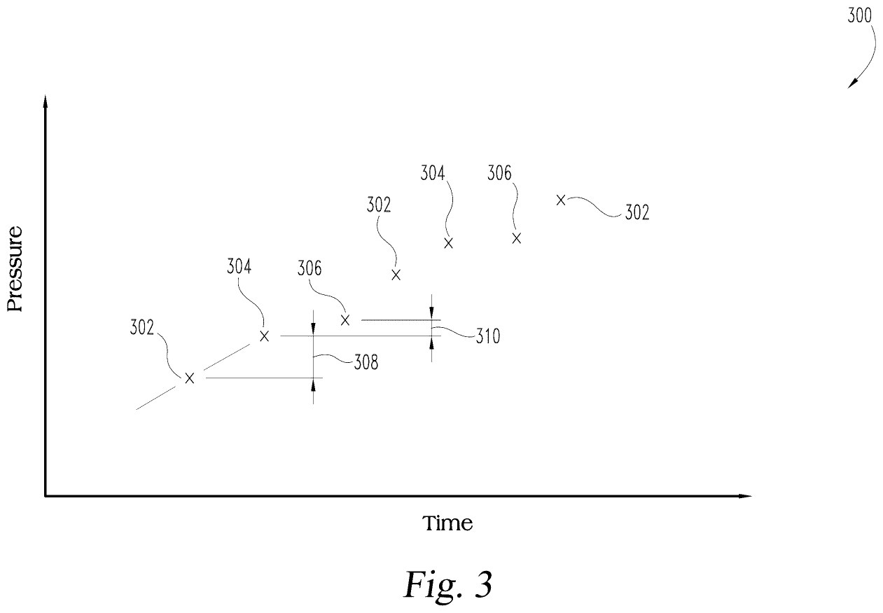

If conditional 214 evaluates affirmative, the pressure measurements 216 may be provided to operation 218, which performs one or more diagnostics or tests all using the pressure measurements 216. The one or more diagnostics or tests may include a number of diagnostics or tests, and example of which is described in connection with operation 220 and FIG. 3.

From operation 218, method 200 proceeds to operation 220, which determines a pump imbalance condition for high-pressure fuel, pump 106. The pump imbalance condition may include, for example, one or more pumping elements (E1 . . . En) producing a high frequency pressure sensor output that differs from the high frequency pressure sensor output of other pumping elements (E1 . . . En) by more than a threshold amount.

For example, FIG. 3 shows a graph 300 plotting hypothetical high frequency pressure sensor data produced by operation of a high-pressure fuel pump 106 including three pumping elements 302, 304, 306. The high frequency output of pumping elements 302, 304 indicates a first pressure increase 308 in fuel rail 108, and the high frequency output of pumping element 306 indicates a second pressure increase 310 in fuel rail 108 from pumping element 306.

A failure condition for pumping element 306 can be determined if, for example, the difference between the first and second pressure increases 308, 310 produced during operation 212 is more than a threshold amount. It should be understood that the diagnostic is not limited to evaluating a single pumping element, but two or more pumping elements can be diagnosed as having a fault if their associated pressure response differs from an expected or benchmark pressure response by more than a threshold amount. It should be further understood that FIG. 3 is simplified and that in actual operation there are several additional data points between the illustrated pressure measurements, and the pressure measurements can be filtered and undergo other data processing.

It should be appreciated that all or a portion of method 200 may be performed in a cloud-based server and/or database. Any expected values for pressure responses and/or differences between pressure responses can be dynamically adjusted based on the distribution of available data on the cloud, for a certain engine operating condition.

Returning to FIG. 2, from operation 220 method 200 continues at operation 222 to output one or more pump diagnostic or test results of the one or more diagnostics performed by operation 220. Outputting the one or more diagnostic results at operation 222 may include communicating, displaying, transmitting, storing, or otherwise outputting the one or more diagnostic results to display an operator perceptible output indicative of a condition of the high-pressure fuel pump 106 and/or diagnose a condition of the high-pressure fuel pump 106.

The diagnostic results for the one or more pumping elements (E1 . . . En) may indicate an individual pumping element and/or cylinder 107 is pumping less than one or more other pumping elements and/or cylinder 107. The reduced pumping may be caused by, for example, a worn piston, failing seals, malfunctioning check valves, worn cam lobes, leakage, or other condition. In addition, the particular pumping element or pumping elements and corresponding cylinder 107 can be identified, facilitating repair. Method 200 may also include logging or storing test results such as diagnostic test results, pressure sensor output data, or other operation associated therewith (e.g., test date and time and/or other diagnostic information associated with the test), disinhibiting fuel injection, and removing any other test overrides.

In an embodiment, one or more engine operating parameters are adjusted in response to one or more pump cylinders 107 being diagnosed as imbalanced. For example, the commanded fuel quantity and fuel pulses can be adjusted to compensate for the imbalance condition. An inlet metering valve command to one or more of the IMV(s) 104 can be adjusted to compensate for the imbalance condition. Other operating parameter adjustments that can be made include one or more of a fuel injection timing, engine speed, IMV positions, engine power output limit, injection duration limit, and exhaust gas recirculation response, a selection of engine cylinders to be skip-fired, and engine protection or derate conditions.

It shall be appreciated that the methodology described in connection with FIG. 3 is one example of a methodology for identifying pressure differences corresponding to individual pumping cylinder elements. Once such information is identified a number analytics and diagnostics may be performed including, for example, comparing or evaluating average pressure increases for multiple pumping elements (E1 . . . En) across multiple pumping events, and comparing or evaluating multiple pressure increases for multiple pumping events for a single pumping element. A number of statistics including variances, weighted averages, and other statistics as will occur to one of skill in the art may also be utilized.

As illustrated by this detailed description, the present disclosure contemplates multiple and various aspects and embodiments, including, without limitation, the following. According to one aspect, a system includes an engine comprising a plurality of combustion chambers and a fueling system comprising a fuel rail in fluid communication with a plurality of fuel injectors. Each of the plurality of fuel injectors is configured to provide fuel to a respective one of the plurality of combustion chambers, and a high-pressure fuel pump is provided that is in fluid communication with the fuel rail. The high-pressure fuel pump includes a plurality of cylinders. The system also includes an electronic control system in operative communication with the fueling system. The electronic control system is configured to operate the high-pressure fuel pump during a diagnostic for the high-pressure fuel pump, receive pressure sensor output indicative of a fuel pressure of the fuel rail during the diagnostic, determine a pressure rise difference between each of the plurality of cylinders of high-pressure fuel pump during the diagnostic based on the pressure sensor output, and in response to the pressure rise difference, display an operator perceptible output indicative of a condition of the high-pressure fuel pump and/or diagnose a condition of the high-pressure fuel pump.

In an embodiment, the electronic control system is configured to operate the high-pressure fuel pump without injecting fuel from the injectors and/or analyze high frequency signals from the pressure sensor output to determine a pumping phase for the high-pressure fuel pump and the pressure rise difference between the plurality of cylinders.

In a further embodiment, the high frequency signals from the pressure sensor output are 10 kilo-Hertz.

In an embodiment, the electronic control system is configured to override an engine speed limit at idle conditions while increasing the fuel rail pressure during the diagnostic.

In an embodiment, the electronic control system is configured to receive pressure sensor output indicative of the fuel pressure of the fuel rail and determine a pumping phase for the high-pressure fuel pump for a plurality of cycles of the engine before the pressure rise difference is determined.

In an embodiment, the electronic control system is operatively coupled with an external diagnostic tool.

In an embodiment, the fuel rail is a high-pressure, common-rail fuel connected to the high-pressure fuel pump.

According to another aspect of the present disclosure, a method of controlling an engine fueling system including a fuel rail in fluid communication with a plurality of fuel injectors is provided. Each of the plurality of fuel injectors is configured to provide fuel to a respective one of a plurality of combustion chambers, and a high-pressure fuel pump is in fluid communication with the fuel rail. The method includes operating the high-pressure fuel pump during a diagnostic for the high-pressure fuel pump, receiving pressure sensor output indicative of a fuel pressure of the fuel rail during the diagnostic, determining a pressure rise difference between each of the plurality of cylinders of high-pressure fuel pump during the diagnostic based on the pressure sensor output, and in response to the pressure rise difference, displaying an operator perceptible output indicative of a condition of the high-pressure fuel pump and/or diagnose a condition of the high-pressure fuel pump.

In an embodiment, the method includes operating the high-pressure fuel pump without injecting fuel from the injectors and/or analyzing high frequency signals from the pressure sensor output to determine a pumping phase for the high-pressure fuel pump and the pressure rise difference between the plurality of cylinders.

In a further embodiment, the high frequency signals from the pressure sensor output are 10 kilo-Hertz.

In an embodiment, the method includes overriding an engine speed limit at idle conditions while increasing the fuel rail pressure during the diagnostic.

In an embodiment, a pumping phase for the high-pressure fuel pump is determined for a plurality of cycles of the engine before the pressure rise difference is determined.

In an embodiment, the method is performed during an out-of-mission service event.

According to another aspect of the present disclosure, an apparatus for testing a high-pressure fuel pump of an engine is provided. The apparatus includes a non-transitory memory medium configured to store instructions executable by a processor to perform the acts of: operating the high-pressure fuel pump during a diagnostic for the high-pressure fuel pump, receiving pressure sensor output indicative of a fuel pressure of the fuel rail during the diagnostic, determining a pressure rise difference between each of the plurality of cylinders of high-pressure fuel pump during the diagnostic based on the pressure sensor output, and in response to the pressure rise difference, displaying an operator perceptible output indicative of a condition of the high-pressure fuel pump and/or diagnose a condition of the high-pressure fuel pump.

In an embodiment, the instructions are executable by the processor to perform the acts of operating the high-pressure fuel pump without injecting fuel from the injectors and/or analyzing high frequency signals from the pressure sensor output to determine a pumping phase for the high-pressure fuel pump and the pressure rise difference between the plurality of cylinders.

In a further embodiment, the high frequency signals from the pressure sensor output are 10 kilo-Hertz.

In an embodiment, the instructions are executable by the processor to perform the acts of over-riding an engine speed limit at idle conditions while increasing the fuel rail pressure during the diagnostic.

In an embodiment, the instructions are executable by the processor to perform the acts of determine a pumping phase for the high-pressure fuel pump over a plurality of cycles of the engine before the pressure rise difference is determined.

In an embodiment, the instructions are configured to operate during an out-of-mission service event.

In an embodiment, the instructions are configured to operate with an external diagnostic tool.

It shall be appreciated that terms such as “a non-transitory memory,” “a non-transitory memory medium,” and “a non-transitory memory device” refer to a number of types of devices and storage mediums which may be configured to store information, such as data or instructions, readable or executable by a processor or other components of a computer system and that such terms include and encompass a single or unitary device or medium storing such information, multiple devices or media across or among which respective portions of such information are stored, and multiple devices or media across or among which multiple copies of such information are stored.

It shall be appreciated that terms such as “determine,” “determined,” “determining” and the like when utilized in connection with a control method or process, an electronic control system or controller, electronic controls, or components or operations of the foregoing refer inclusively to a number of acts, configurations, devices, operations, and techniques including, without limitation, calculation or computation of a parameter or value, obtaining a parameter or value from a lookup table or using a lookup operation, receiving parameters or values from a datalink or network communication, receiving an electronic signal (e.g., a voltage, frequency, current, or pulse-width modulation (PWM) signal) indicative of the parameter or value, receiving output of a sensor indicative of the parameter or value, receiving other outputs or inputs indicative of the parameter or value, reading the parameter or value from a memory location on a computer-readable medium, receiving the parameter or value as a run-time parameter, and/or by receiving a parameter or value by which the interpreted parameter can be calculated, and/or by referencing a default value that is interpreted to be the parameter value.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A system comprising:
an engine comprising a plurality of combustion chambers;
a fueling system comprising a fuel rail in fluid communication with a plurality of fuel injectors, each of the plurality of fuel injectors being configured to provide fuel to a respective one of the plurality of combustion chambers, and a high-pressure fuel pump in fluid communication with the fuel rail, the high-pressure fuel pump including a plurality of cylinders; and
an electronic control system in operative communication with the fueling system and configured to:
operate the high-pressure fuel pump during a diagnostic for the high-pressure fuel pump,
receive pressure sensor output indicative of a fuel pressure of the fuel rail during the diagnostic,
determine a pressure rise difference between each of the plurality of cylinders of high-pressure fuel pump during the diagnostic based on the pressure sensor output, and
in response to the pressure rise difference, display an operator perceptible output indicative of a condition of the high-pressure fuel pump and/or diagnose a condition of the high-pressure fuel pump.

2. The system of claim 1, wherein the electronic control system is configured to operate the high-pressure fuel pump without injecting fuel from the injectors and/or analyze high frequency signals from the pressure sensor output to determine a pumping phase for the high-pressure fuel pump and the pressure rise difference between the plurality of cylinders.

3. The system of claim 2, wherein the high frequency signals from the pressure sensor output are 10 kilo-Hertz.

4. The system of claim 1, wherein the electronic control system is configured to override an engine speed limit at idle conditions while increasing the fuel rail pressure during the diagnostic.

5. The system of claim 1, wherein the electronic control system is configured to receive pressure sensor output indicative of the fuel pressure of the fuel rail and determine a pumping phase for the high-pressure fuel pump for a plurality of cycles of the engine before the pressure rise difference is determined.

6. The system of claim 1, wherein the electronic control system is operatively coupled with an external diagnostic tool.

7. The system of claim 1, wherein the fuel rail is a high-pressure, common-rail fuel connected to the high-pressure fuel pump.

8. A method of controlling an engine fueling system including a fuel rail in fluid communication with a plurality of fuel injectors, each of the plurality of fuel injectors configured to provide fuel to a respective one of a plurality of combustion chambers, and a high-pressure fuel pump in fluid communication with the fuel rail, the method comprising:
operating the high-pressure fuel pump during a diagnostic for the high-pressure fuel pump,
receiving pressure sensor output indicative of a fuel pressure of the fuel rail during the diagnostic,
determining a pressure rise difference between each of the plurality of cylinders of high-pressure fuel pump during the diagnostic based on the pressure sensor output, and
in response to the pressure rise difference, displaying an operator perceptible output indicative of a condition of the high-pressure fuel pump and/or diagnose a condition of the high-pressure fuel pump.

9. The method of claim 8, further comprising operating the high-pressure fuel pump without injecting fuel from the injectors and/or analyzing high frequency signals from the pressure sensor output to determine a pumping phase for the high-pressure fuel pump and the pressure rise difference between the plurality of cylinders.

10. The method of claim 9, wherein the high frequency signals from the pressure sensor output are 10 kilo-Hertz.

11. The method of claim 8, further comprising over-riding an engine speed limit at idle conditions while increasing the fuel rail pressure during the diagnostic.

12. The method of claim 8, wherein a pumping phase for the high-pressure fuel pump is determined for a plurality of cycles of the engine before the pressure rise difference is determined.

13. The method of claim 8, wherein the method is performed during an out-of-mission service event.

14. An apparatus for testing a high-pressure fuel pump of an engine, the apparatus comprising:
a non-transitory memory medium configured to store instructions executable by a processor to perform the acts of:
operating the high-pressure fuel pump during a diagnostic for the high-pressure fuel pump,
receiving pressure sensor output indicative of a fuel pressure of the fuel rail during the diagnostic,
determining a pressure rise difference between each of the plurality of cylinders of high-pressure fuel pump during the diagnostic based on the pressure sensor output, and
in response to the pressure rise difference, displaying an operator perceptible output indicative of a condition of the high-pressure fuel pump and/or diagnose a condition of the high-pressure fuel pump.

15. The apparatus of claim 14, wherein the instructions are executable by the processor to perform the acts of:
operating the high-pressure fuel pump without injecting fuel from the injectors and/or analyzing high frequency signals from the pressure sensor output to determine a pumping phase for the high-pressure fuel pump and the pressure rise difference between the plurality of cylinders.

16. The apparatus of claim 15, wherein the high frequency signals from the pressure sensor output are 10 kilo-Hertz.

17. The apparatus of claim 14, wherein the instructions are executable by the processor to perform the acts of:
over-riding an engine speed limit at idle conditions while increasing the fuel rail pressure during the diagnostic.

18. The apparatus of claim 14, wherein the instructions are executable by the processor to perform the acts of:
determine a pumping phase for the high-pressure fuel pump over a plurality of cycles of the engine before the pressure rise difference is determined.

19. The apparatus of claim 14, wherein the instructions are configured to operate during an out-of-mission service event.

20. The apparatus of claim 14, wherein the instructions are configured to operate with an external diagnostic tool.
